(19) United States
(12) Patent Application Publication
(10) Pub. No.: US 2011/0005359 A1
(43) Pub. Date: Jan. 13, 2011

(54) TOOL WITH ADJUSTABLE WORKING ANGLE

(76) Inventor: Cheng-Wei SU, Taichung City (TW)

Correspondence Address: Dr. BANGER SHIA;Patent Office of Bang Shia, 102 Lindencrest Ct., Sugar Land, TX, 77479-5201, US

(21) Appl. No.: 12/872,094

(22) Filed: Aug. 31, 2010

Related U.S. Application Data
(63) Continuation-in-part of application No. 12/500,437, filed on Jul. 9, 2009.

(51) Int. Cl. B25B 23/16

(52) U.S. Cl. 81/177.7

(57) ABSTRACT

A tool with adjustable working angle, wherein a connecting member of the tool is provided with a strengthened portion which is thicker than the thickness of a first or second connecting portion of the connecting member, so that four standing surfaces are formed at connections of the first connecting portion, the four standing surfaces have the same height, which means that the connecting member is a balanced structure, so that torque can be evenly and smoothly transmitted from the first or second connecting portion to the strengthened portion to prevent deformation.

This application is a continuation in part of U.S. patent application Ser. No. 12/500,437, which claims the benefit of the earlier filing date of Jul. 9, 2009.

### BACKGROUND OF THE INVENTION

1. Field of the Invention

The present invention relates to a tool with adjustable working angle, and more particularly to a tool with a strengthened connecting member.

2. Description of the Prior Art

Referring to FIG. 1, a conventional tool with adjustable working angle comprises a connecting member 20, a first rod 30 and a second rod 40. The first rod 30 is axially provided on one end thereof with two spaced first clamping portions 32, 33 each of which has an aligned first hole 321, 331, and the second rod 40 is axially provided on one end thereof with two spaced second clamping portions 42, 43 each of which has an aligned second hole 421, 431. By such arrangements, the connecting member 20 can be clamped by the first clamping portions 32, 33 of the first rod 30 and the second clamping portions 42, 43 of the second rod 40, respectively, and then two pins 51, 52 are inserted through the first holes 321, 331 of the first clamping portions 32, 33 and the second holes 421, 431 of the second clamping portions 42, 43, respectively to make the first and the second rods 30, 40 be pivotally connected to the connecting member 20.

It is to be noted that, referring to FIG. 2, when the conventional tool with adjustable working angle performs the turning operation, the connecting member 20 installed between the first and the second rods 30, 40 will be subjected to quite high working torque, specifically, the first and the second rods 30, 40 synchronously apply a torque on two opposite ends of the connecting member 10, thus leading to the deformation of the middle portion of the connecting member 20.

In addition, it is impossible to enhance the structural strength of the connecting member 20 by directly increasing thickness, since the connecting member 20 needs to be pivotally connected between the clamping portions of the first and the second rods 30, 40, in other words, the structure interference should be considered if the thickness of the connecting member 20 is increased to enhance the structural strength.

The present invention has arisen to mitigate and/or obviate the afore-described disadvantages.

### SUMMARY OF THE INVENTION

The primary object of the present invention is to provide a tool with adjustable working angle, wherein a connecting member of the tool is provided with a strengthened portion which is thicker than the thickness of a first or second connecting portion of the connecting member, so that four standing surfaces are formed at connections of the first connecting portion, the four standing surfaces have the same height, which means that the connecting member is a balanced structure, so that torque can be evenly and smoothly transmitted from the first or second connecting portion to the strengthened portion to prevent deformation.

### BRIEF DESCRIPTION OF THE DRAWINGS

FIG. 1 is a perspective view of a conventional tool with adjustable working angle;

FIG. 2 is an operational view showing that the conventional tool with adjustable working angle of FIG. 1 deforms due to torque;

FIG. 3 is an exploded view of a tool with adjustable working angle in accordance with the present invention;

FIG. 4 is a combinational view of the tool with adjustable working angle in accordance with the present invention;

FIG. 5 is an enlarged view of a connecting member of the tool with adjustable working angle in accordance with the present invention;

FIG. 6 is a side view of the connecting member of the tool with adjustable working angle in accordance with the present invention;

FIG. 7 is an operational view of the tool with adjustable working angle in accordance with the present invention; and

FIG. 8 is another operational view of the tool with adjustable working angle in accordance with the present invention.

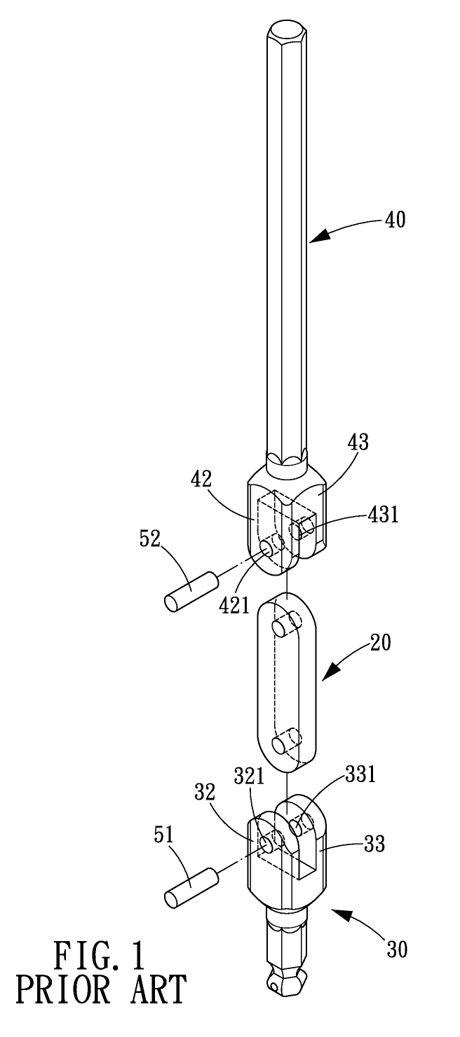

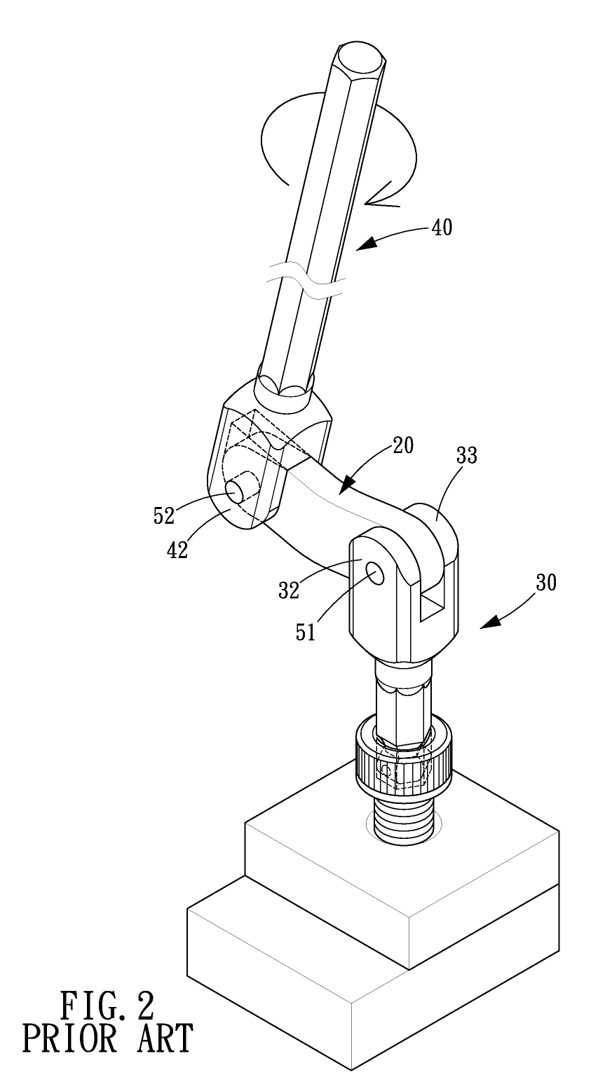

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

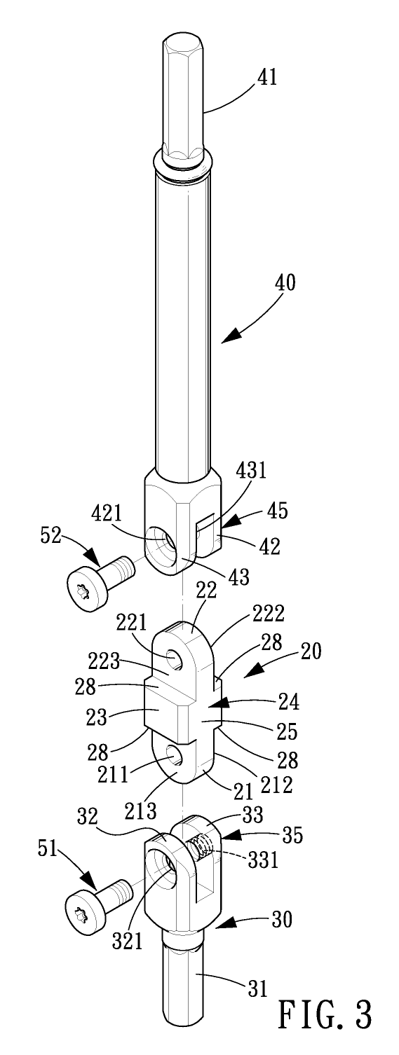

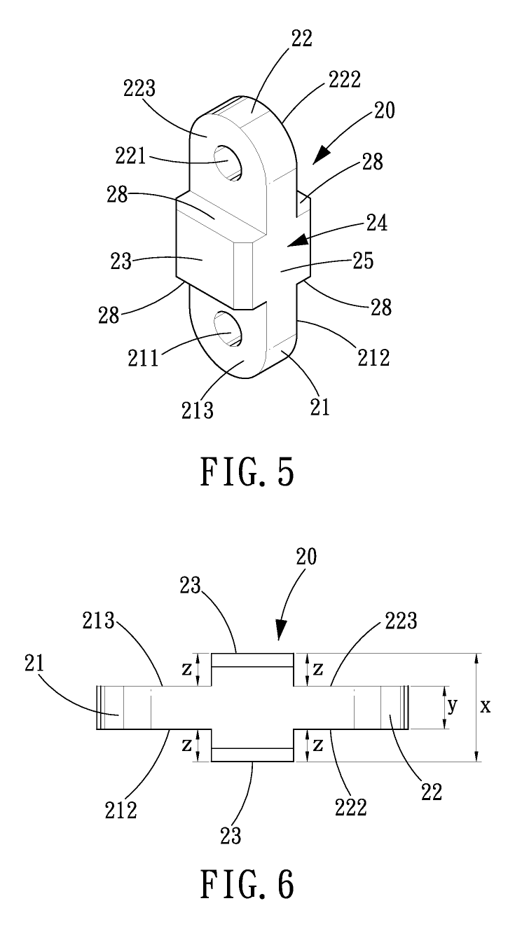

Referring to FIGS. 3-6, a tool with adjustable working angle in accordance with the present invention comprises: a connecting member 20, a first rod 30 and a second rod 40.

The connecting member 20 is provided with a strengthened portion 24 which includes two opposite longitudinal surfaces 25 and two opposite transverse surfaces 23. A thickness between the two opposite transverse surfaces 23 is X. The connecting member 20 is further provided at both ends thereof with a first connecting portion 21 and a second connecting portion 22 which extend from both ends of the strengthened portion 24, respectively. A thickness between two opposite transverse surfaces 212 and 213 of the first connecting portion 21 is the same as a thickness between two opposite transverse surfaces 222 and 223 of the a second connecting portion 22 and is defined as Y. In the first connecting portion 21 is defined a first pivot hole 211, and in the second connecting portion 22 is defined a second pivot hole 221. The thickness X is larger than Y, so that four standing surfaces 28 are formed at the connections of the first connecting portion 21, the second connecting portion 22 and the strengthened portion 24. The four standing surfaces 28 are the same in height, and a height of each standing surface 28 is Z which is measured from the transverse surfaces 23 of the strengthened portion 24 to the corresponding transverse surfaces 212, 213, 222, 223 of the first and second connecting portions 21, 22.

The first rod 30 is provided with a working portion 31 at one end thereof and a connecting portion 35 at the other. The connecting portion 35 includes two first clamping portions 32, 33 each of which has an aligned first hole 321, 331. The first clamping portions 32 and 33 are separated from each other by a space and are to be clamped against the first connecting portion 21 of the connecting member 20 in such a manner that the first holes 321, 331 of the first clamping portions 32, 33 are aligned with the first pivot hole 211 of the connecting member 20.

A first pivot 51, which is a bolt, is inserted through the first pivot hole 211 of the first connecting portion 21, the first hole 321 of the first rod 30 and finally screwed into the first hole 331 which is a threaded hole, so that the first rod 30 is pivotally connected to the connecting member 20.

The second rod 40 is provided with a working portion 41 at one end thereof and a connecting portion 45 at the other. The connecting portion 45 includes two second clamping portions 43, 42 each of which has an aligned second hole 421, 431. The second clamping portions 42 and 43 are separated from each other by a space and are to be clamped against the second connecting portion 22 of the connecting member 20 in such a manner that the second holes 421, 431 of the second clamping portions 42, 43 are aligned with the second pivot hole 221 of the connecting member 20.

A second pivot 52, which is a bolt, is inserted through the second pivot hole 221 of the second connecting portion 22, the second hole 421 of the second rod 40 and finally screwed into the second hole 431 which is a threaded hole, so that the second rod 40 is pivotally connected to the connecting member 20.

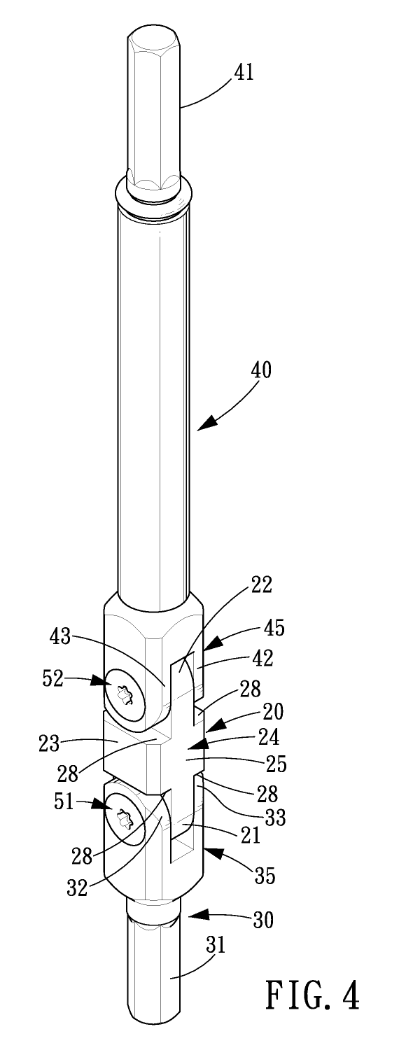

For a better understanding of the present invention, reference should be made to FIGS. 4-6 again, the connecting member 20 is provided with the strengthened portion 24, and the thickness X between the two opposite transverse surfaces 23 of the strengthened portion 24 is larger than the thickness Y between the two opposite transverse surfaces 212 and 213 of the first connecting portion 21 (or opposite transverse surfaces 222 and 223 of the second connecting portion 22), such that, when the tool of the present invention is used to turn a fastener, the connecting member 20 is less likely to deform when subjected to torque of the tool.

It is to be noted that the thickness X is larger than the thickness Y of the first or second connecting portion 21, 22, so that four standing surfaces 28 are formed at the connections of the first connecting portion 21, the second connecting portion 22 and the strengthened portion 24. The four standing surfaces 28 have the same height Z, which means that the connecting member 20 is a balanced structure, so that torque can be evenly and smoothly transmitted from the first or second connecting portion 21, 22 to the strengthened portion 24, preventing deformation.

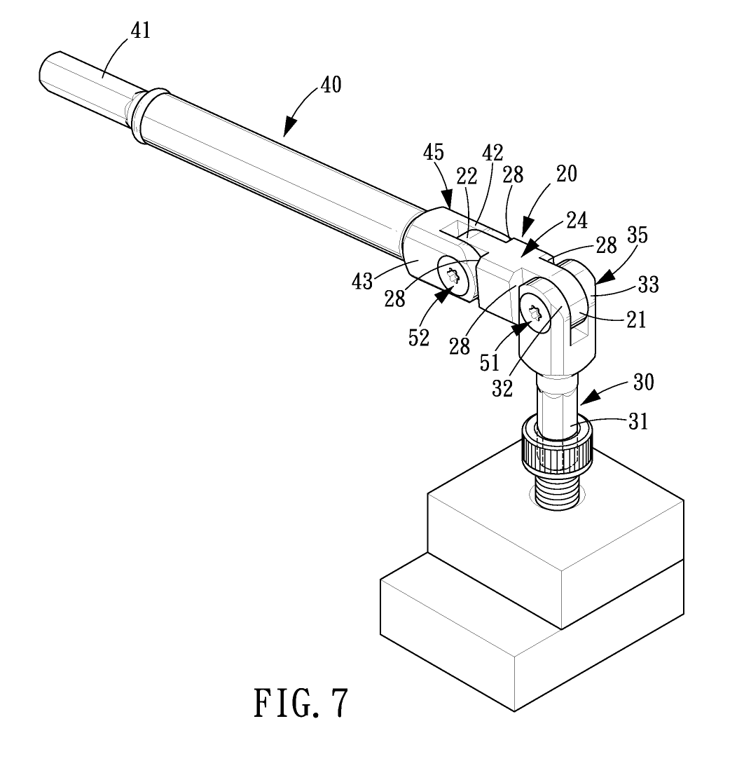

As shown in FIG. 7 which is an operational view of the tool with adjustable working angle in accordance with the present invention, showing that the first rod 30 which has been rotated at a predetermined angle is turning a screw, the tool with adjustable working angle in accordance with the present invention is adjusted into an L shape to perform the turning operation, at this moment, the strengthened portion 24 and the respective standing surfaces 28 won't affect the operation of the tool with adjustable working angle in accordance with the present invention.

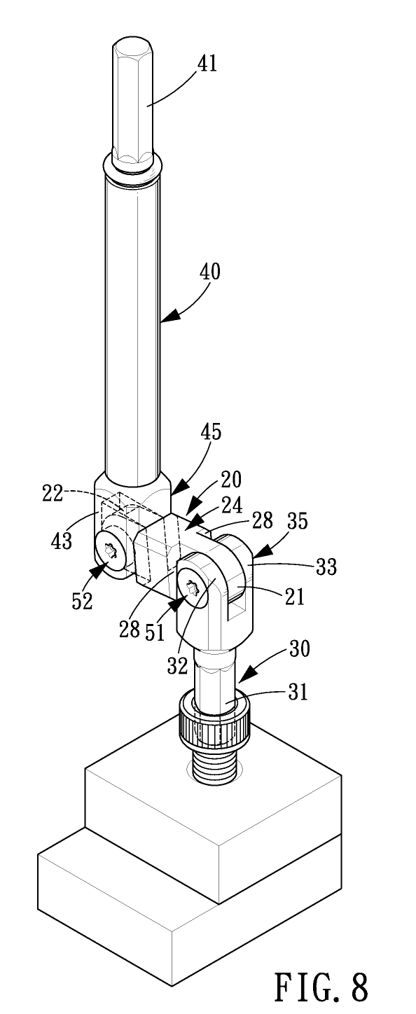

As shown in FIG. 8 which is another operational view of the tool with adjustable working angle in accordance with the present invention, showing that the first rod 30 and the second rod 40 which are both rotated at a predetermined angle is turning a screw, the tool with adjustable working angle in accordance with the present invention is adjusted into an N shape to perform the turning operation, at this moment, the strengthened portion 24 and the respective standing surfaces 28 won't affect the operation of the tool with adjustable working angle in accordance with the present invention.

While we have shown and described various embodiments in accordance with the present invention, it is clear to those skilled in the art that further embodiments may be made without departing from the scope of the present invention.

What is claimed is:

1. A wrench with two rods connected by a connecting member, comprising:
the connecting member with a strengthened portion which includes two opposite longitudinal surfaces and two opposite transverse surfaces, the connecting member being further provided at both ends thereof with a first connecting portion and a second connecting portion which extend from both ends of the strengthened portion, respectively, a thickness between the two opposite transverse surfaces of the first connecting portion being the same as a thickness between two opposite transverse surfaces of the a second connecting portion and smaller than a thickness between the two opposite transverse surfaces of the strengthened portion of the connecting member, in the first connecting portion being defined a first pivot hole, and in the second connecting portion being defined a second pivot hole, so that four standing surfaces are formed at connections of the first connecting portion, the second connecting portion and the strengthened portion, the four standing surfaces being the same in height, and a height of each standing surface is measured from the transverse surfaces of the strengthened portion to the transverse surfaces of the first and second connecting portions;
a first rod being provided with a working portion at one end thereof and a connecting portion at the other, the connecting portion including two first clamping portions each of which has an aligned first hole, the first clamping portions being separated from each other by a space and clamped against the first connecting portion of the connecting member in such a manner that the first holes of the first clamping portions are aligned with the first pivot hole of the connecting member;
a first pivot inserted through the first pivot holes of the first connecting portion and the first holes of the first rod, so that the first rod is pivotally connected to the connecting member;
a second rod being provided with a working portion at one end thereof and a connecting portion at the other, the connecting portion of the second rod including two second clamping portions each of which has an aligned second hole, the second clamping portions of the second rod being separated from each other by a space and clamped against the second connecting portion of the connecting member in such a manner that the second holes of the second clamping portions are aligned with the second pivot hole of the connecting member; and
a second pivot inserted through the second pivot hole of the second connecting portion and the second holes of the second rod, so that the second rod is pivotally connected to the connecting member.
